(19) United States
(12) Patent Application Publication
(10) Pub. No.: US 2016/0041410 A1
(43) Pub. Date: Feb. 11, 2016

(54) INTERCHANGEABLE EYEGLASS FRAME DESIGNS

(71) Applicant: Richard Carson Bailey, Monticello, IN (US)

(72) Inventor: Richard Carson Bailey, Monticello, IN (US)

(21) Appl. No.: 14/455,480

(22) Filed: Aug. 8, 2014

(51) Int. Cl. G02C 11/02

(52) U.S. Cl. CPC G02C 11/02

(57) ABSTRACT

An eyeglass sleeve is provided. The eyeglass sleeve may include a sidewall having an elongated length and forming an elongated channel within the sidewall. The sidewall may further include a first edge and a second edge, each running along the elongated length of the sidewall. The first and second edge form an opening in between that leads to the elongated channel. The sidewall is made of a resilient stretchable material and is formed to receive and secure at least a portion of a glasses frame within the elongated channel.

### BACKGROUND OF THE INVENTION

The present invention relates to eyeglasses and, more particularly, to interchangeable eyeglass frame designs.

Glasses, also known as eyeglasses (formal) or spectacles, are frames bearing lenses worn in front of the eyes. They are normally used for vision correction. Sunglasses allow better vision in bright daylight, and may protect one's eyes against damage from high levels of ultraviolet light. Sometimes glasses are worn simply for aesthetic or fashion purposes. Currently, the style of the glasses cannot be changed. Therefore, to accessorize glasses with jewelry or a wardrobe, a user must wear a different pair of glasses. The average eyeglass wearer may only own one or two pairs of glasses, and therefore appropriately accessorizing may not be an option.

As can be seen, there is a need for a glasses that may be accessorized.

### SUMMARY OF THE INVENTION

In one aspect of the present invention, an eyeglass sleeve comprises: a sidewall comprising an elongated length and forming an elongated channel within, wherein the sidewall comprises a first edge and a second edge, each running along the elongated length of the sidewall, wherein the first edge and the second edge form an opening in between leading into the elongated channel, wherein the sidewall is made of a resilient stretchable material and wherein the sidewall is formed to receive and secure at least a portion of a glasses frame within the elongated channel.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention, shown in use

FIG. 2 is an exploded view of an embodiment of the present invention;

FIG. 3 is a section view of the an embodiment of present invention, taken along line 3-3 in FIG. 1

FIG. 4A is an exploded detail of the top of FIG. 3;

FIG. 4B is an assembled detail of the top of FIG. 3;

FIG. 5A is an exploded detail of the bottom of FIG. 3;

FIG. 5B is an assembled detail of the bottom of FIG. 3;

FIG. 6 is a section view of the an embodiment of present invention, taken along line 6-6 in FIG. 1

FIG. 7 is a detailed section view of the bottom of FIG. 6;

FIG. 8A is a section view, taken along line 8A-8A in FIG. 6;

FIG. 8B is an exploded detail of FIG. 8A;

FIG. 9 is a front view of the top eyeglass sleeve;

FIG. 10 is a back view of the top eyeglass sleeve;

FIG. 11 is a side view of the top eyeglass sleeve;

FIG. 12 is a section view, taken along line 12-12 in FIG. 9;

FIG. 13 is a section view, taken along line 13-13 in FIG. 9;

FIG. 14 is a front view of the bottom eyeglass sleeve;

FIG. 15 is a section view, taken along line 15-15 in FIG. 14;

FIG. 16 is a section view, taken along line 16-16 in FIG. 14;

FIG. 17 is a right side view of a temple eyeglass sleeve;

FIG. 18 is a left side view of a temple eyeglass sleeve; and

FIG. 19 is a section view, taken along line 19-19 in FIG. 17.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a device and method that allows a large variety of interchangeable frame sleeves to be fastened to a single frame-base (which may includes the lenses). Frame bases may be available in a variety of sizes and shapes and may be made of metal or plastic. Frame sleeves may be made of rubber or plastic or any material with sufficient elasticity to allow the sleeves to be easily attached to the frame bases and as easily removed. The eyeglass sleeves may come in a wide variety of shapes and ornamentation that can include a wide range of designs utilizing color, glitter, precious metals, embedded gems, graphical elements; e.g., hearts, polka-dots, wavy lines, etc. The present invention saves money since the glasses may now be accessorized without the purchase of multiple glasses. The present invention allows wearers to coordinate their glasses with jewelry and wardrobes.

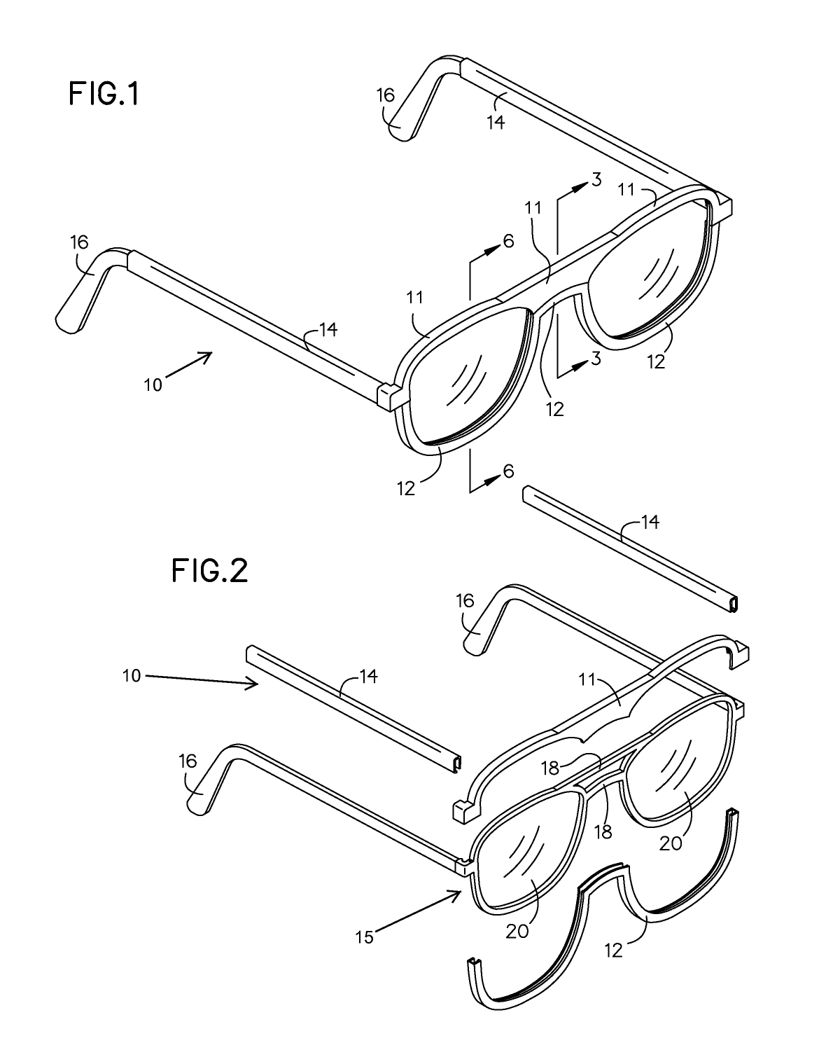

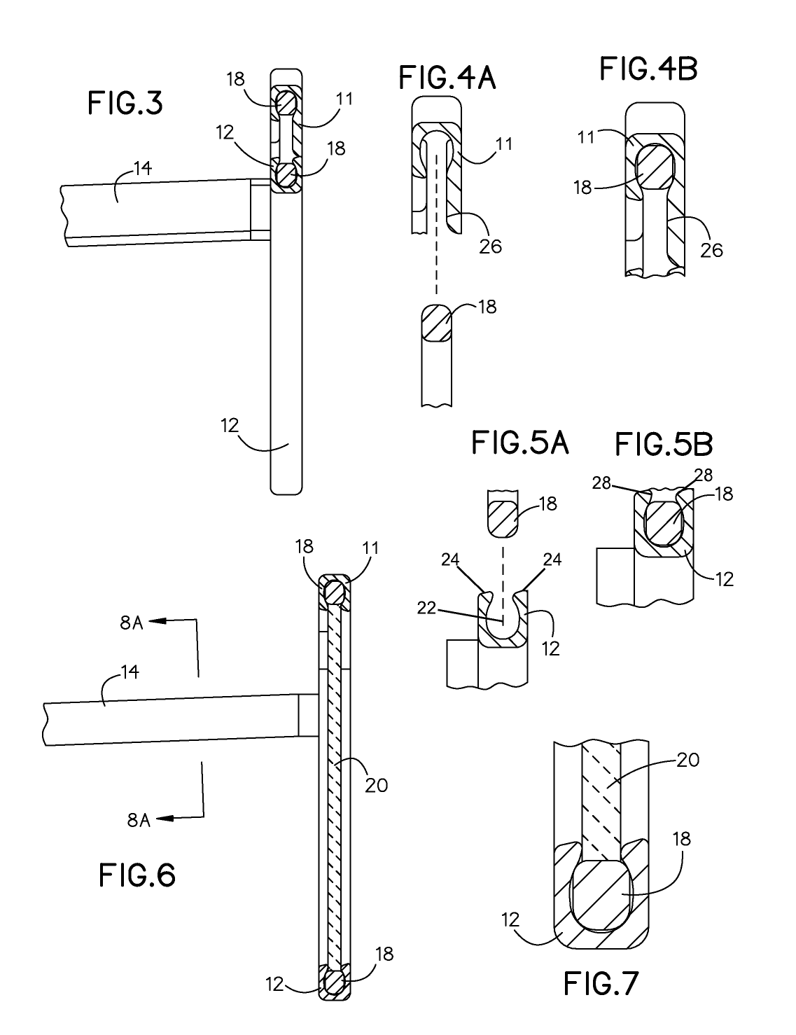

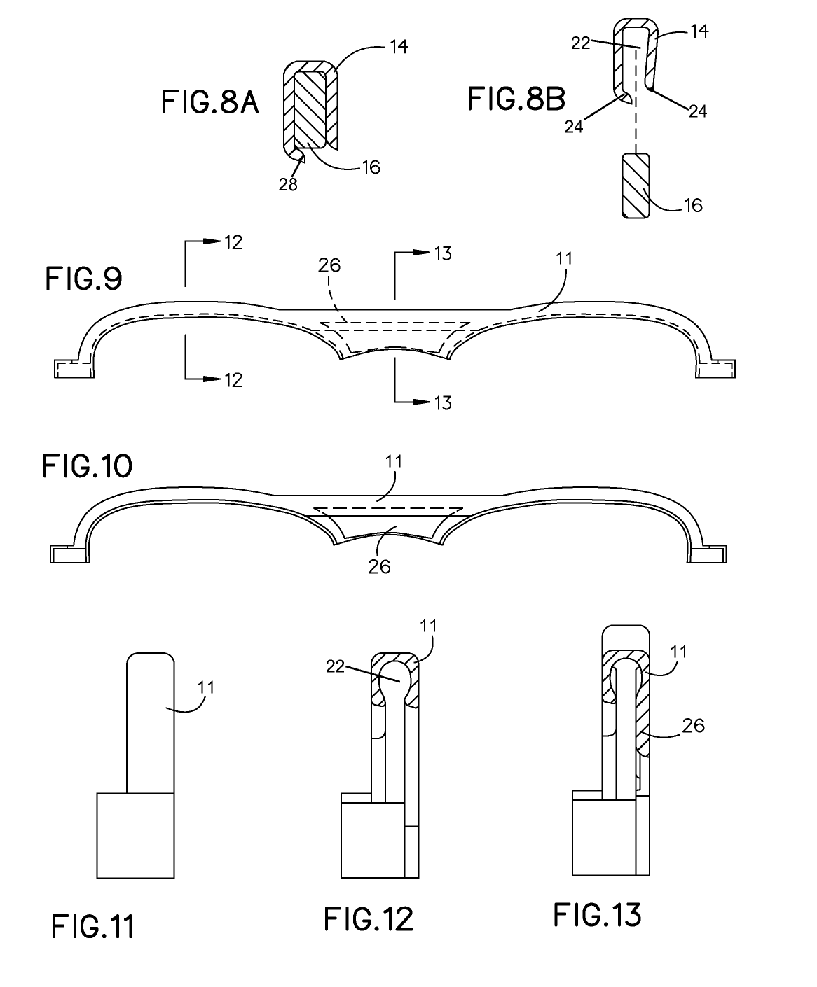

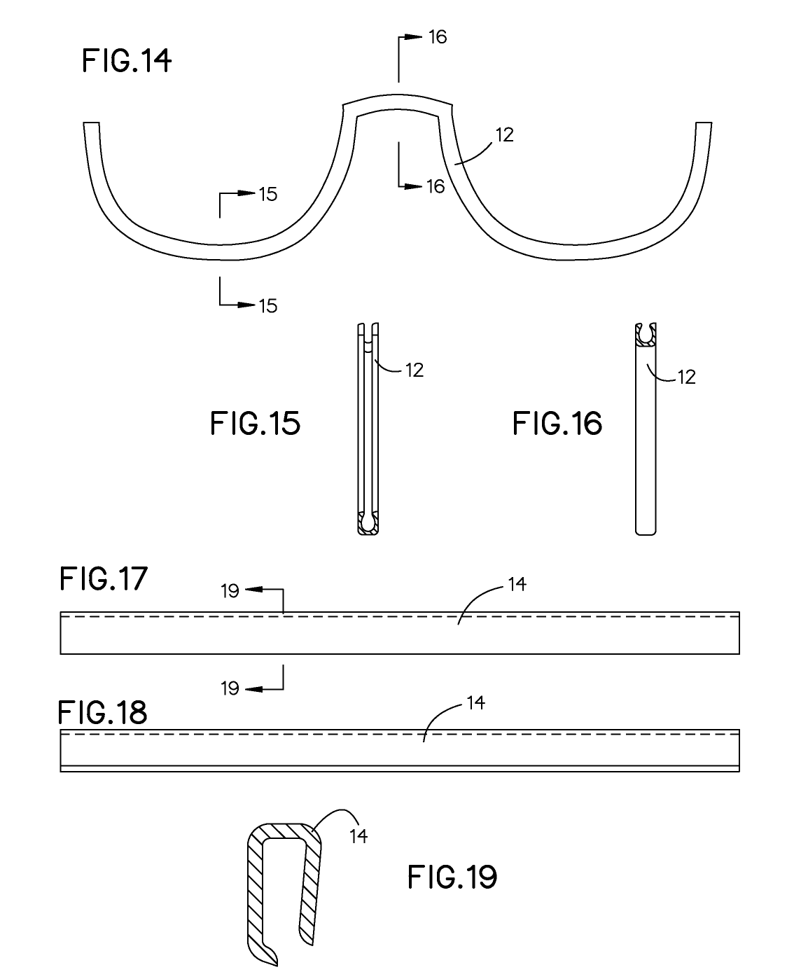

Referring to FIGS. 1 through 19, the present invention includes an eyeglass sleeve 10. The eyeglass sleeve 10 includes a sidewall having an elongated length (I) and forming an elongated channel 22 within the sidewall. The sidewall may further include a first edge 24 and a second edge 24, each running along the elongated length (I) of the sidewall. The first and second edge 24 form an opening in between that leads to the elongated channel 22. The sidewall is made of a resilient stretchable (elastic) material and is formed to receive and secure at least a portion of a glasses frame 15 within the elongated channel 22. The resilient stretchable material of the sidewall may be able to return to an original shape after being pulled, stretched, pressed, bent and the like. The resilient stretchable material may be rubber, plastic or other substantially similar material.

Since the sidewall is made of the resilient stretchable material, the elongated channel 22 may snuggly secure to the glasses frame 15. For example, the elongated channel 22 may include an inner perimeter cross section that is slightly smaller than an outer perimeter cross section of the glasses frame 15. Therefore, the sidewall may be stretched over the glasses frame 15 and snuggly fit on at least a portion of the glasses frame 15.

In certain embodiments, a lip 28 may extend from the edges 24 to further secure the sidewall to the glasses frame 15. In such embodiments, at least one of the first edge 24 and the second edge 24 may include a lip 28 protruding towards the opening of the channel 22. Therefore, when the glasses frame 15 is within the channel 22, the lip 28 may further prevent the glasses frame 15 from slipping out of the channel 22.

In certain embodiments, the sidewall may include a base, and a first side and a second side protruding from the base. The first side and the second side includes the first edge 24 and the second edge 24 respectively. To further retain the glasses frame 15 within the channel 22, at least one of the first side and the second side may be biased towards the elongated channel 22. Therefore, when the glasses frame 15 is placed within the elongated channel 22, the first side, the second side, or both may be pressed up against the glasses frame 15, preventing the glasses frame 15 from slipping out of the channel 22.

The present invention may include a plurality of eyeglass sleeves 10 that fit and cover one glasses frame 15. In certain embodiments, the eyeglass sleeve 10 may include a temple sleeve 14. The temple sleeve 14 may include the sidewall being substantially straight along the elongated length. Therefore, the eyeglass sleeve 10 may be formed to fit over a temple frame 16 of the glasses frame 15. As illustrated in the Figures, the present invention may include two temple sleeves 14 that fit on both of the temple frames 16.

The plurality of eyeglass sleeves 10 may further include a bottom sleeve 12. The bottom sleeve 12 may include at least one curvature formed to fit over the glasses frame 15, below the lens 20. In certain embodiments, the bottom sleeve 12 may include two curvatures and a bridge portion. The two curvatures are formed to fit over the glasses frame 15 below the two lenses 20 and the bridge portion is formed to fit over a lower portion of the bridge 18 of the glasses frame 15.

In certain embodiments, the plurality of eyeglass sleeves 10 may include a top sleeve 11. The top sleeve 11 may include two curvatures and a bridge portion in between. The two curvatures are formed to fit over the glasses frame 15 above the two lenses 20 and the bridge portion is formed to fit over an upper portion of the bridge 18 of the glasses frame 15. In certain embodiments, the top sleeve 11 may include a protrusion 26 extending downward. The protrusion 26 is formed to cover the bridge of the glasses frame 15. The protrusion 26 may be adjacent to the bridge portion of the bottom sleeve 12, covering the entire bridge.

In certain embodiments, either the top sleeve 11 or the bottom sleeve 12 may include ends that conform to the joining of the temple frames 16 with the lens frames. For example, as illustrated in the Figures, the top sleeve 11 may include channels 22 that include substantially right angles at the ends, covering the corners of the glasses frame 15.

A method of using the present invention may include the following. Users of the present invention may first select a frame. The user may then choose a particular sleeve that coordinates with their clothes and jewelry. The sleeves may be attached to the frame at the temple portion, and at the top and bottom of the lens portion. The sleeves may easily be squeezed onto the frames due to the resilient stretchable material. The sleeves may fit snuggly against the frames.

It should be understood, of course, that the foregoing relates to exemplary embodiments of the invention and that modifications may be made without departing from the spirit and scope of the invention as set forth in the following claims.

What is claimed is:

1. An eyeglass sleeve comprising:
a sidewall comprising an elongated length and forming an elongated channel within,
wherein the sidewall comprises a first edge and a second edge, each running along the elongated length of the sidewall,
wherein the first edge and the second edge form an opening in between leading into the elongated channel,
wherein the sidewall is made of a resilient stretchable material and wherein the sidewall is formed to receive and secure at least a portion of a glasses frame within the elongated channel.

2. The eyeglass sleeve of claim 1, wherein at least one of the first edge and the second edge comprises a lip protruding towards the opening.

3. The eyeglass sleeve of claim 2, wherein the first edge and the second edge comprise a lip protruding towards the opening.

4. The eyeglass sleeve of claim 1, wherein the elongated channel comprises an inner perimeter cross section that is slightly smaller than an outer perimeter cross section of the glasses frame, thereby snuggly fitting on at least a portion of the glasses frame.

5. The eyeglass sleeve of claim 1, wherein the resilient stretchable material is a rubber.

6. The eyeglass sleeve of claim 1, wherein the sidewall is substantially straight along the elongated length and formed to fit over a temple frame of the glasses frame.

7. The eyeglass sleeve of claim 1, wherein the sidewall comprises at least one curvature formed to fit over the glasses frame below a lens.

8. The eyeglass sleeve of claim 7, wherein the sidewall comprises two curvatures and a bridge portion in between, wherein the two curvatures are formed to fit over the glasses frame below the two lenses and the brigde portion is formed to fit over a lower portion of a bridge of the glasses frame

9. The eyeglass sleeve of claim 1, wherein the sidewall comprises two curvatures and a bridge portion in between, wherein the two curvatures are formed to fit over the glasses frame above the two lenses and the bridge portion is formed to fit over an upper portion of a bridge of the glasses frame.

10. The eyeglass sleeve of claim 9, wherein the bridge portion comprises a protrusion extending downward, wherein the protrusion is formed to cover the bridge of the glasses frame.

11. The eyeglass sleeve of claim 1, wherein the sidewall comprises a base, and a first side and a second side protruding from the base, wherein the first side and the second side comprise the first edge and the second edge respectively.

12. The eyeglass sleeve of claim 11, wherein at least one of the first side and the second side is biased towards the elongated channel.
